(19) United States
(12) Patent Application Publication
(10) Pub. No.: US 2007/0255587 A1
(43) Pub. Date: Nov. 1, 2007

(54) Clinical trial finance management system

(76) Inventors: Janet C. Chien, Boston, MA (US); Patricia J Horne, Concord, MA (US)

Correspondence Address: KRISTOFER E. ELBING, 187 PELHAM ISLAND ROAD, WAYLAND, MA, 01778, US

(21) Appl. No.: 11/414,942

(22) Filed: May 1, 2006

(51) Int. Cl. G06Q 10/00; G06Q 40/00

(52) U.S. Cl. 705/2; 705/35

(57) ABSTRACT

A clinical trial finance management system is disclosed. It includes a clinical trial that can interact with clinical trial data associated with a clinical trial plan, and a financial management interface that can interact with financial data associated with the clinical trial plan. Relationship management logic is provided to interact with the clinical trial interface, to interact with the financial management interface, and to manage relationships between the clinical trial data and the financial data based on the clinical trial plan.

### BACKGROUND OF THE INVENTION

Specialized software programs have been developed to handle the logistical and regulatory requirements of clinical trials. These programs automate the process of managing a clinical trial by tracking the administration of treatments and placebos and the resulting effects on patients. But because clinical trials typically pose a high risk and cost for biopharmaceutical companies, further improvements in trial efficiency would be helpful in improving overall company productivity and reducing the cost of bringing new treatments to market.

### SUMMARY OF THE INVENTION

In one general aspect, the invention features a clinical trial finance management system that includes a clinical trial interface operative to interact with clinical trial data associated with a clinical trial plan. A financial management interface is operative to interact with financial data associated with the clinical trial plan. Relationship management logic is also provided. This logic is operative to interact with the clinical trial interface, operative to interact with the financial management interface, and operative to manage relationships between the clinical trial data and the financial data based on the clinical trial plan.

In preferred embodiments, the clinical trial interface can include a system interface operative to interact with a clinical trial management system that uses the clinical trial data. The financial management interface can include a system interface operative to interact with a financial management system that uses the financial data. The financial management interface can include a user interface that includes controls that allow the user to access the financial data. The relationship management logic can be operative to manage relationships at the patient level. The relationship management logic can be operative to manage relationships at the protocol level. The relationship management logic can include cost-type logic that associates different types of clinical trial items with different types of financial treatments. The cost-type logic can include mandatory selection logic that requires users to classify at least some clinical trial items by cost type. The relationship management logic can include hierarchical clinical trial item organization logic. The stored relationship selection interface can be operative to present a tree-based user interface window to the user. The relationship management logic can include hierarchical clinical trial item organization logic. The stored relationship selection interface can be operative to present a tree-based user interface window to the user. The clinical trial plan can be defined by clinical trial contract line items, with the relationship management logic being operative to associate different types of clinical trial contract line items from the clinical trial management system with different types of financial items. The relationship management logic can include audit trail logic operative to create audit trails for the relationships. The audit trail logic can be designed to conform to predetermined compliance standards. The system can further include supply management logic operative to manage relationships between supply costs with patient-level clinical trial management data from the clinical trial management system. The system can further include fulfillment logic operative to manage fulfillment of clinical trial materials. The system can further include inventory management logic operative to manage inventory for clinical trial materials. The system can further include forecast logic operative to derive forward-looking cost information based on the supply management logic. The system can further include report logic operative to generate reports summarizing information from the system. The system can further include state logic operative to log states of the system over time. The system can further include management approval logic operative to gate functionality in the system based on management approval input. The system can further include forecast logic operative to derive forward-looking cost information based on patient-level clinical trial management data from the clinical trial management system. The system can further include a plurality of different management tools for different relationship management tasks. The system can further include accrual calculation logic operative to calculate accrued costs for a clinical trial. The system can further include invoicing logic operative to manage invoices for services or materials for a clinical trial. The system can further include expense tracking logic operative to track expenses for a clinical trial. The relationship management logic can include exchange rate calculation logic operative to capture exchange rates at discrete points over time to enable tracking of changes in costs.

In another general aspect, the invention features a clinical trial finance management method that includes accessing clinical trial data associated with a clinical trial plan, accessing financial data associated with the clinical trial plan, and automatically maintaining a set of relationships between the clinical trial data from the step of accessing a clinical trial management system and the financial data from the step of accessing financial data based on the clinical trial plan.

In a further general aspect, the invention features a clinical trial finance management system that includes means for accessing clinical trial data associated with a clinical trial plan, means for accessing financial data associated with the clinical trial plan, and means for automatically maintaining a set of relationships between the clinical trial data accessed by via the means for accessing clinical trial data and the financial data accessed via the means for accessing financial data, based on the clinical trial plan.

Systems according to the invention may be advantageous in that they can automatically manage relationships between clinical trial goals and financial transactions that are linked to them. This can allow tasks related to financial management of a clinical trial to be seamlessly managed by a team of individuals with different responsibilities and skill sets. Information from the system can also be readily queried and aggregated at different levels to enhance budgeting, auditing, and the evaluation of service providers. System information can also be used to forecast and plan current and future trials.

Systems according to the invention can be particularly well suited to helping biopharmaceutical companies to make better estimates of accrued expenses for clinical trials. This process involves identifying services that third parties have performed on the company's behalf and estimating the level of service performed and the associated cost incurred on these services as of each balance sheet date in company financial statements. Errors in this process can result in inaccurate reporting of company earnings, and, given the high cost of clinical trials, inaccuracies associated with clinical trial expenses can potentially be quite large.

### BRIEF DESCRIPTION OF THE DRAWINGS

FIG. 1 is a block diagram of a clinical trial financial management system according to the invention;

FIG. 2 is a screen shot of a main menu for the clinical trial financial management system of FIG. 1, showing a clinical trial financial management system database load dialog;

FIG. 3 is a screen shot of a product master screen for the clinical trial financial management system of FIG. 1;

FIG. 4 is a screen shot of a product group master screen for the clinical trial financial management system of FIG. 1;

FIG. 5 is a screen shot of CRO maintenance screen for the clinical trial financial management system of FIG. 1, showing a CRO budget item maintenance tab selected;

FIG. 6 is a screen shot of the CRO maintenance screen of FIG. 5, showing a CRO setup tab selected;

FIG. 7 is a screen shot of the CRO maintenance screen of FIG. 5, showing a CRO contract setup tab selected and a contract details subtab selected;

FIG. 8 is a screen shot of the CRO maintenance screen of FIG. 5, showing the CRO contract setup tab selected and a fixed and variable cost subtab selected;

FIG. 9 is a screen shot of a CRO invoice review screen for the clinical trial financial management system of FIG. 1;

FIG. 10 is a screen shot of a per patient fee/cycle cost screen for the clinical trial financial management system of FIG. 1;

FIG. 11 is a screen shot of an invoice accounts payable screen for unvouchered invoices for the clinical trial financial management system of FIG. 1;

FIG. 12 is a screen shot of a data model maintenance screen for the clinical trial financial management system of FIG. 1, showing a DM master tab selected;

FIG. 13 is a screen shot of a data model maintenance screen of FIG. 12, showing a DM contract setup tab selected;

FIG. 14 is a screen shot of a data model invoice screen for the clinical trial financial management system of FIG. 1;

FIG. 15 is a screen shot of a protocol master screen for the clinical trial financial management system of FIG. 1, showing a protocol time line tab selected;

FIG. 16 is a screen shot of the protocol master screen of FIG. 15, showing a site details tab selected;

FIG. 17 is a screen shot of the protocol master screen of FIG. 15, showing a general ledger details tab selected;

FIG. 18 is a screen shot of an accrual adjustment screen for the clinical trial financial management system of FIG. 1;

FIG. 19 is a screen shot of a foreign exchange rate master screen for the clinical trial financial management system of FIG. 1;

FIG. 20 is a screen shot of a month-end accrual calculation screen for the clinical trial financial management system of FIG. 1;

FIG. 21 is a screen shot of a manufacturer master screen for the clinical trial financial management system of FIG. 1;

FIG. 22 is a screen shot of an outsourced clinical inventory forecast screen for the clinical trial financial management system of FIG. 1;

FIG. 23 is a screen shot of a product inventory screen for the clinical trial financial management system of FIG. 1;

FIG. 24 is a screen shot of a product unit cost screen for the clinical trial financial management system of FIG. 1;

FIG. 25 is a screen shot of a purchase order screen for the clinical trial financial management system of FIG. 1;

FIG. 26 is a screen shot of clinical product forecast screen for the clinical trial financial management system of FIG. 1;

FIG. 27 is a screen shot of an clinical trials forecast screen for the clinical trial financial management system of FIG. 1;

FIG. 28 is a screen shot of drug production forecast screen for the clinical trial financial management system of FIG. 1;

FIG. 29 is a flow chart outlining accounting accrual for the clinical trial financial management system of FIG. 1;

FIG. 30 is a flow chart outlining accrual calculation logic for the clinical trial financial management system of FIG. 1;

FIG. 31 is a flow chart outlining accrual calculation logic for the CRO patient cost type for the clinical trial financial management system of FIG. 1; and

FIG. 32 is a flow chart outlining accrual calculation logic for the CGO patient cost type for the clinical trial financial management system of FIG. 1.

### DETAILED DESCRIPTION OF AN ILLUSTRATIVE EMBODIMENT

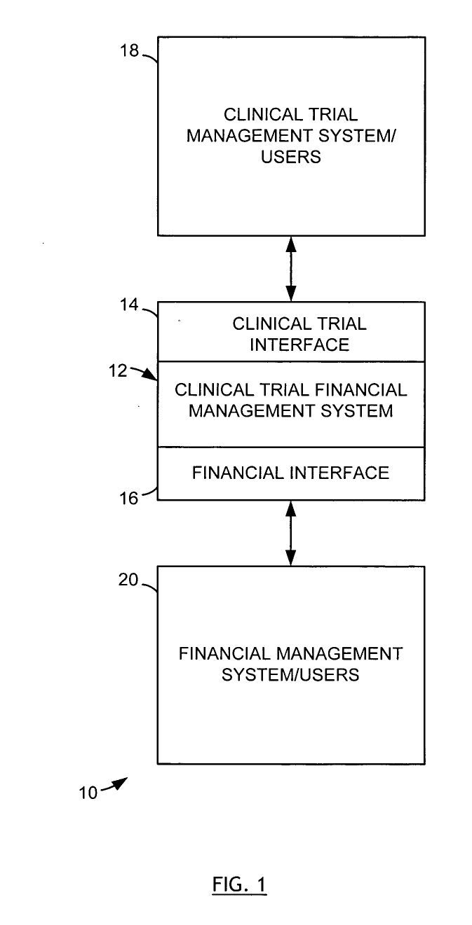

Referring to FIG. 1, an illustrative clinical trial financial management system 12 according to the invention includes a clinical trial interface 14 and a financial interface 16. In this system, the clinical trial interface interacts directly with an off-the-shelf clinical trial management system 18. This interface may also include a user interface that provides access to the system by clinical trial management personnel. Similarly, the financial interface in this system provides a user interface that provides access to the system by financial management personnel, but this interface could also directly interact with financial management software 20.

The illustrative embodiment described in this application is implemented as a Visual Basic software program designed to operate in cooperation with networked Microsoft Windows®-based computers. Other software platforms could of course also be supported, such as Web-based platforms, and some or all of the system could even be implemented using dedicated hardware. The illustrative system is also designed to use the Peachtree accounting software product available from Sage Software, Inc. as its financial management software 20, although other accounting systems, including off-the shelf and custom systems, could also be supported. The clinical trial management system 18 used in the illustrative system is a custom system, but differently designed custom systems or off-the-shelf programs could also be supported.

The functionality and user interface described are intended to illustrate features and functions of the invention. But one of ordinary skill in the art would recognize that there may be other possible ways to various aspects of the claimed invention. To this end, the functions and controls shown could be modified, swapped, merged, split up, or combined in ways not shown. Other types of controls could also implement claimed functionality, and some of the controls may even be omitted without departing from the spirit and scope of the invention.

The financial management system 12 tracks costs for each trial based on contractual and product information. It can track third party expenses and accruals, including drug product (DP), raw material (API), and patient care costs. It can also monitor budgets by comparing actual costs to estimates.

The financial management system 12 enables the user to record contract details for each trial. The system can be designed to handle trials that are delegated to a Contract Research Organization (CRO) or to a Clinical Grant Organization (CGO), such as a hospital. It can also handle agreements with other discrete service providers, such as consultants, attorneys, or Data Monitoring (DM) services. The line-item budget for the protocol, including a provision for attributing line item expenses to predetermined project phases, is entered with the contract setup information. The system also allows for the user to create a general ledger for recording income and expenses, to generate invoices to clinical vendors, to record receivables from clinical vendors, and to print protocol cost summary reports.

The financial management system 12 can be used by a number of different individuals working from different workstations and having different responsibilities in an organization that sponsors clinical trials. It is therefore preferably password protected to avoid unauthorized access or tampering. In the illustrative embodiment, each username must be greater than five and not more than 15 alphanumeric characters long, and the password must be greater than five and not more than 20 alphanumeric characters long.

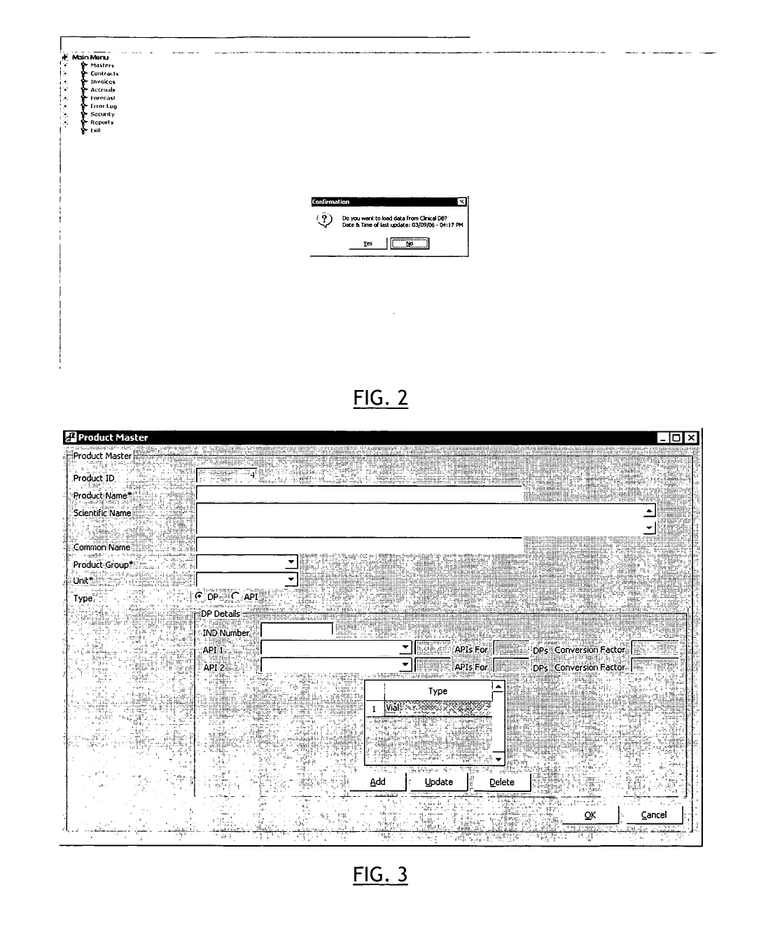

Referring to FIG. 2, once the user has logged in using his or her password, the financial management system presents the user with a main menu screen. This menu first prompts the user to load clinical data from a database into the financial clinical trial management system 18 (e.g., into a dedicated database for the financial clinical trial management system). The clinical data base and the financial data management system contain parallel fields, labeled with the same nomenclature, so that data from the clinical data base can be uploaded to the financial data base. If the data already exists in the financial clinical trial management database, it is overwritten with the current data retrieved from the clinical database.

The main menu screen then allows the user to navigate to the various screens in the application. In the illustrative embodiment, this menu includes category entries for masters, contracts, invoices, accruals, forecasts, error logging, security, and reports. It presents these entries in a collapsible outline format allowing the user to access individual screens within a category. As with other parts of the system, one of ordinary skill in the art could readily design different ways to access the screens, through different sets of menus, or through different user interface metaphors.

Referring to FIG. 3, a product master screen can be used to maintain product details for either a Drug Product (DP) or an Active Pharmaceutical Ingredient (API). The product master screen includes text fields for entering a product's ID, its product name, its scientific name, its common name, and its product group.

Each product tracked by the financial management system has a unique identifier, called a product ID, which is automatically generated and displayed in a text field. In the illustrative embodiment, the ID can contain a maximum of 5 alphanumeric characters and is a mandatory field. The product name is also a mandatory, but is displayed in a much longer field. The scientific name and common name fields are also longer fields, but are not mandatory.

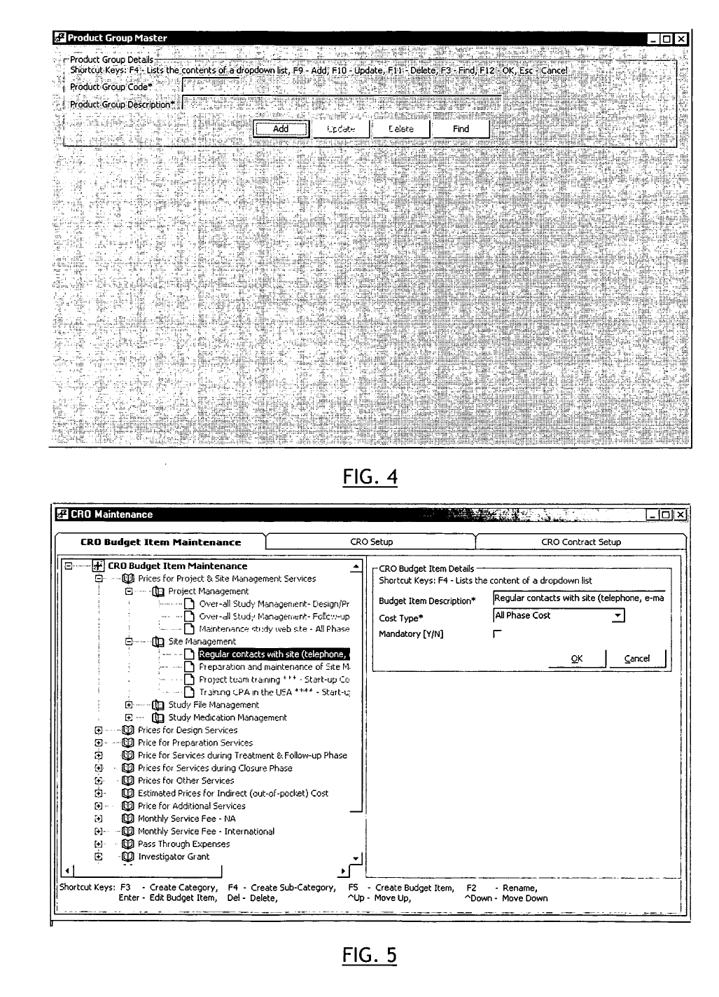

The product group is selected by the user from a dropdown list and is displayed in a text field labeled “product group.” One product group can have multiple products but a product can be related to only one product group. Product group details can be managed through the use of a product group master screen, which is shown in FIG. 4.

The product master screen can also list a unique agency tracking number for the drug product to which it refers. In the case of US FDA trials, this number is referred to as an IND number.

Further listed in the product master screen is an API component table for the DP to which it refers. Each line of this table corresponds to one API in the DP, and lists its name, the number of API units in each DP dose, and a conversion factor. The API makeup information for the DP is retrieved from a manufacturer table, which can be managed using a manufacturer master screen (see FIG. 21). The conversion factor is calculated by the financial management system 12.

The user can select a product type, as well, and enter it in a text field labeled “type.” The type field conveys whether the product is administered by vials, capsule, other means, or a combination of means. This information is also retrieved from the manufacturer table and presented to the user in a drop down list.

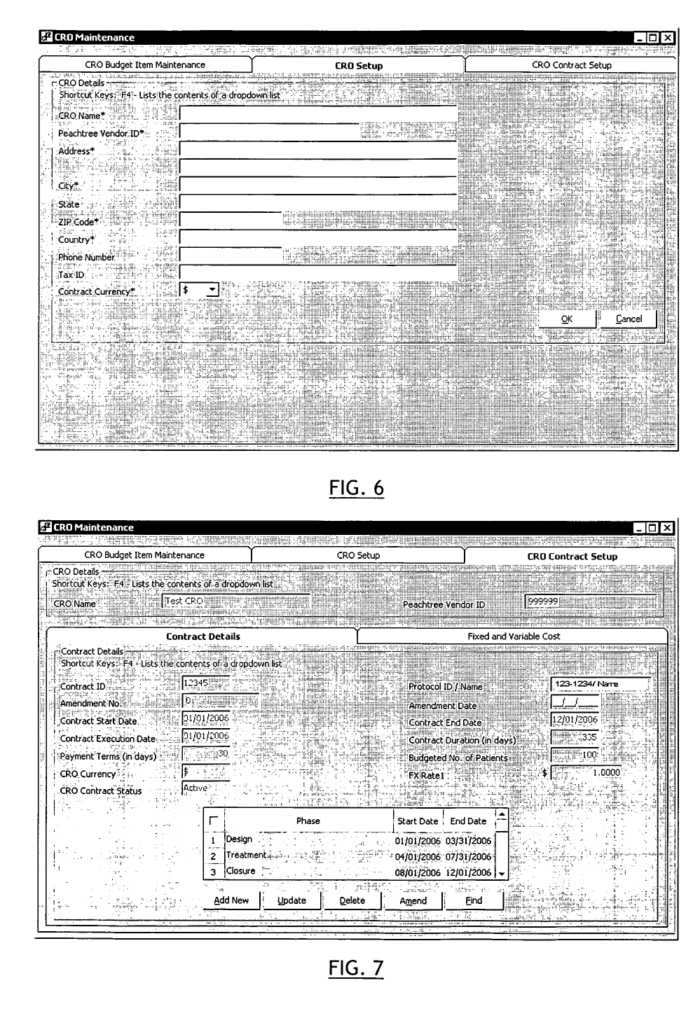

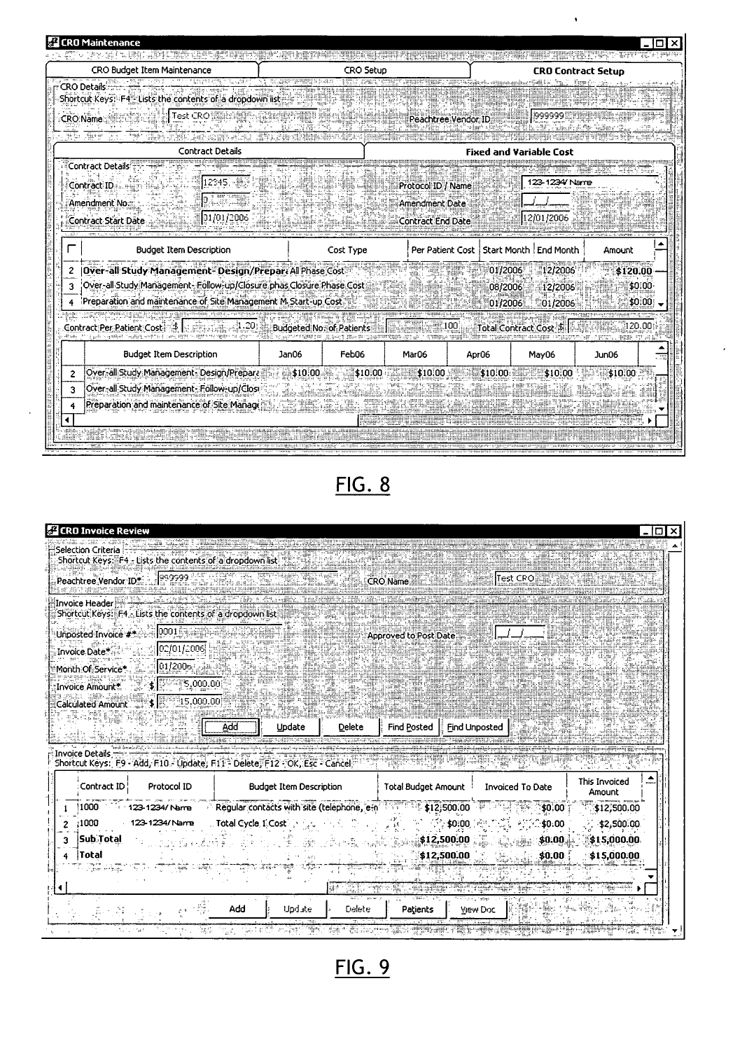

Referring to FIGS. 5-8, the financial management system 12 can also provide the user with a CRO management screen. This screen can have three tabs, a CRO budget item maintenance tab (FIG. 5), a CRO setup tab (FIG. 6), and a CRO contract setup tab (FIGS. 7-8).

Referring to FIG. 6, The CRO setup tab is generally used first to add a CRO to the system. This screen receives the name of a CRO, its vendor ID (e.g., as used by Peachtree), its tax ID, and its contact address and phone number. This screen also allows the user to select a currency for the CRO, which will be used in all of its contracts. Like many of the screens and tabs provided by the financial management system 12, the CRO setup tab allows the user to add new records, update or delete existing records, or just find and view information from existing records.

Referring to FIG. 7, once a CRO has been set up in the system, the user can set up contracts for that CRO using two subtabs of the CRO contact setup tab. In the illustrative embodiment, one CRO can have contracts on multiple protocols but one protocol can have only one CRO contract. A contract details subtab is used to enter CRO contract-related information including execution date, contract start/end date details, and timeline details. A fixed and variable cost subtab is used to enter fixed and variable cost details. This information can then be used by the system and referenced through the CRO contract setup tab.

When a contract is added, the CRO maintenance screen displays the CRO name and the vendor ID. The contract details subtab provides access to fields pertaining to contract details, including contract ID and protocol ID/name, amendment number and amendment date, contract start-up date and contract end date, contract execution date and contract duration (displayed in number of days), payment terms (displayed in number of days), budgeted number of patients, CRO currency, exchange rate on date of contract execution, and CRO contract status (active or inactive.). The user enters this information into the drop down menu when the contract is added. After the information is added, it is saved to provide an audit trail.

The contract ID number is entered by the user in the contract ID field. In the illustrative embodiment, the contract ID may contain up to six digits, and must be unique for the CRO.

In the illustrative embodiment, the protocol ID/name must be unique for the CRO. The protocol ID and name appear together, separated by a slash. The protocol ID/name is retrieved from information entered into the protocol master.

A contract amendment must also be assigned an amendment number unique for the contract. This alphanumeric number and the date the amendment is added are entered by the user. The date should be greater than contract start date and greater than the contract execution date.

A contract execution date, or start date is entered in the contract date field by the user. The user also enters a contract end date in the contract end date field. The contract end date should be greater than contract start date. A contract duration field can also be provided as a display field. This duration is calculated based on the contract start and end date, and can be displayed as a three-digit integer representing the number of days for the contract.

Payment terms for the contract are generally determined by the contract and entered in the payment terms field by the user. A number of patients can be entered by the user in a field labeled “budgeted number of patients.” This number can include a fractional part.

A CRO currency field on the CRO contract setup screen is a display field only, with the currency having been selected for the CRO in the CRO setup tab. The currency conversion rate is entered by the user in a foreign exchange rate field labeled “FX rate.” This field is used for the conversion rate for the home currency (US dollars in the illustrative system) at the time of contract execution. The CRO contract setup screen can also provide a field that allows the user to attach or otherwise associate some or all of the text of the contract with the screen.

The CRO contract details subtab can also include a contract phase table to track the phase of the contract. This table includes a line for each phase of the contract and it is populated by the user when the contract is set up. Each line includes a phase name, such as design, treatment and closure.

Referring to FIG. 5, the CRO budget item maintenance tab maintains budget item details for CROs. To create a budget item, the user scrolls down the left margin and highlights a field within which to enter the name of the new CRO budget item. The budget item tree has three levels. Items can be in any of the three levels. The first level is the category level, the second level is for sub-categories, and the third level is for budget line items. The names at all of these levels are user-created.

In the illustrative system, each budget item must have a cost type attached to it that should be selected from the drop-down list. This rigid treatment of cost types helps to impose a uniform and predictable treatment to budget items. In the illustrative embodiment, there are six cost types provided, and no screen is provided to allow users to alter cost types.

Referring to FIG. 8, the fixed and variable cost subtab allows the user to track a contract's fixed and variable costs using contract setup information, and to track the budget items created using the budget item maintenance tab. It displays the fixed and variable cost details for the selected contract. It also shows consolidated and monthly budget item views.

Fixed costs can be displayed in a grid that includes columns for a budget item description, a cost type, a per-patient cost, a start month, an end month, and an item amount. The user begins to populate this list by entering a name for an item is in a budget item description field using a drop-down list, which can be hierarchical like the budget item maintenance tab. The user can also use a “mass update” command to prepopulate the list with some or all of the budget items in the system.

Values in the cost type column are derived from the budget item for that column. The start and end months are derived from information entered in the contract details tab. The user enters the item amount as specified in the contract for the trial. The per-patient cost is automatically calculated from the item amount in the case of patient cost items.

Variable costs can be displayed in a grid that includes a column for a budget item description, and a series of month columns. The budget item list column can mirror the budget item column in the fixed cost grid. The number of month columns can be based on the interval between the start month and the end month in the fixed cost grid. The system can also automatically divide the item costs by this interval and enter the result in each month column. The user can then make adjustments to these numbers.

In the illustrative embodiment, in-house CGO functionality is similar to that for CROs. Some additional fields are provided for in-house tracking purposes, and additional controls are provided to allow trials to be broken down into cycles. The exact set of features provided is of course preferably tailored to the specific needs of the sponsor organization.

Referring to FIG. 9, a CRO invoice review screen is provided to enter invoices. All of the invoices are entered in the unvouchered state. When the invoices are approved for posting, the approval to post date is entered and the invoices move to the next stage. Once the invoices are posted, the accrual side of the general ledger is debited and the A/P section of the general ledger is credited, and the entry can no longer be edited. One invoice can have one or more contract related budget items.

The user enters an invoice number in a field labeled “unposted invoice number.” The invoice date is entered by the user as a date in the field labeled “invoice date.” The month that he invoice covers is entered as a date in the field labeled “month of service.” The sum of the invoice detail line amount is calculated and displayed in a numeric field labeled “calculated amount.” The date that the invoice is posted is entered as a date in the field labeled “approved to post date.” Exchange rate information is also provided, as will be discussed below in connection with FIG. 19.

Invoice details are displayed in display fields as follows: contract ID, protocol ID, budget item description, total budget amount, invoice to date, this invoice amount, total invoice to date, budget remaining, comments, and then any attachment. The contract ID is displayed on a dropdown list in a field labeled “contract ID,” and is retrieved from information entered into the contract setup screen. The protocol ID/name is displayed in the field labeled “protocol name/ID,” and is retrieved from information entered into the contract setup screen. The budget item description is displayed as text, and is retrieved from information entered into the contract setup screen. The budgeted amount is retrieved from the information entered into contract setup screen. The total invoice amount for all the invoices received to date is calculated and displayed in a numeric field labeled “Invoiced to Date.” The amount of the current invoice is entered by the user in a numeric field labeled “this invoiced amount.” The total invoiced to date, comprising the cumulative invoiced to date up to and including the current invoice (“this invoiced amount”) is tallied and displayed in the numeric field labeled “total invoiced to date.” The budgeted amount less the invoiced to date amount is calculated and displayed in a numeric field labeled “Budget Remaining.” The user may also enter an attached text document, or enter comments.

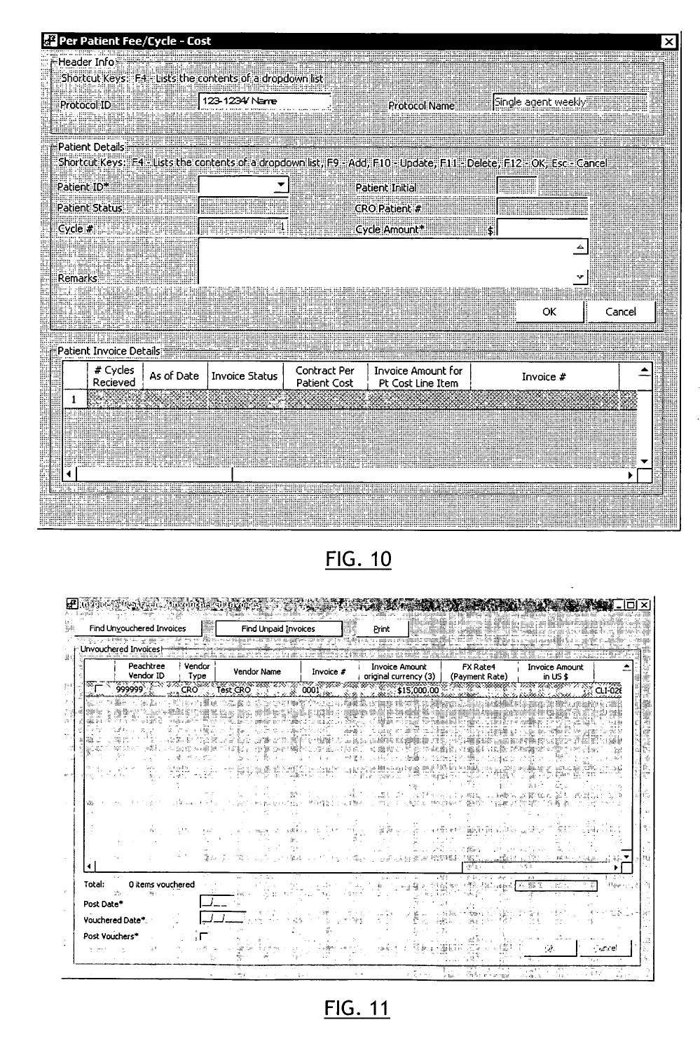

Referring to FIG. 10, the user can record the patient fee/cycle details for an invoice using a “patient view” screen. Multiple sites are allowed for each patient in an invoice. The protocol ID is selected from a dropdown list. The patient name is not a mandatory field and may be displayed in a field labeled “patient name.” The patient's initials are similarly not mandatory, but may be displayed in a field labeled “patient's initials.” The patient ID, however, is a mandatory field. The patient's status is displayed in the field labeled “patient status.” The CRO patient number is displayed in a field labeled “CRO patient #.” The stage of a patient's drug treatment called a cycle number can be displayed in the numeric field labeled “cycle #.” The user can enter a cycle amount in the numeric field labeled “cycle amount.”

The patient invoiced details section of the screen displays the details of the previously entered invoices for the patient selected. This section has fields to display the number of cycles received to date, the invoice status, the contract per patient cost, the invoice amount for patient cost line item, the invoice number, and any remarks. These are display fields only.

Referring to FIG. 11, an invoice A/P screen displays CRO and CGO invoices approved for payment via the invoice review screen. This screen is typically used by an accounting professional as part of his or her monthly routine. This screen allows the user to view voucher and payment details including: vendor ID, vendor type (CGO or CRO), vendor name, invoice #, invoice amount original currency, payment rate, invoice amount in US dollars, protocol ID, total items, total vouchered amount, post date, transaction date, and whether or not to post vouchers.

The posting date is entered by the user as a date in a numeric field labeled “post date.” The transaction date is entered by the user as a date in a numeric field labeled “transaction date.” The decision to post the vouchers is entered by the user as either yes or no in a Boolean field labeled “post vouchers.” Find and print functions are also provided.

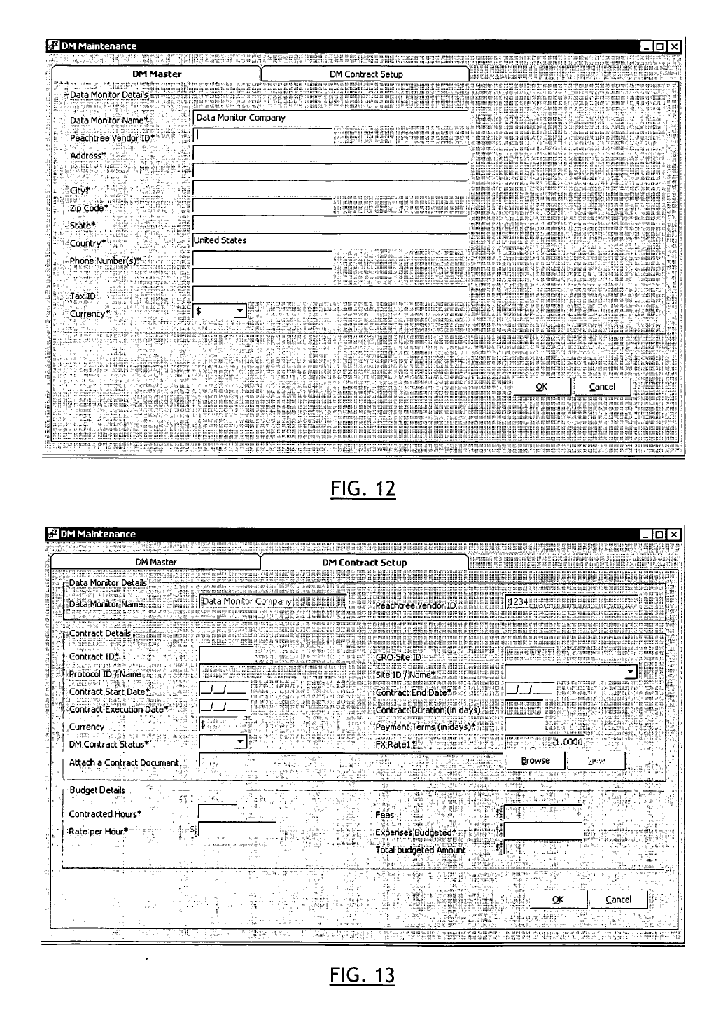

Referring to FIG. 12, a DM master tab is available through a DM maintenance screen. Like the CRO setup tab, this tab maintains DM details as well as the currency details. The currency details are used in the DM contract and DM invoices.

Referring to FIG. 13, the user can set up a DM contract using a DM contract setup tab. Like the CRO contract setup tab, this tab maintains the DM contract details. It also maintains budgets and actual costs on an hourly basis.

Budget details can be itemized and displayed in fields on the screen. The user enters the number of contracted hours in a mandatory text field. The pay rate per hour is entered in a mandatory numeric field labeled “rate per hour.” Field fees are calculated as a product of the number of hours at the contracted rate per hour, and are displayed in a numeric field labeled “fees.” Budgeted expenses are calculated and displayed in a numeric field labeled “expenses budgeted.” Budget expenses are those fixed costs pre-determined at the line item phase of the budget setup process. For DMs, all costs are cost type 2, meaning that they affect the general ledger equally each month over the entire contract term. The fees and expenses budgeted are automatically calculated and displayed in a numeric field labeled “total budgeted amount.”

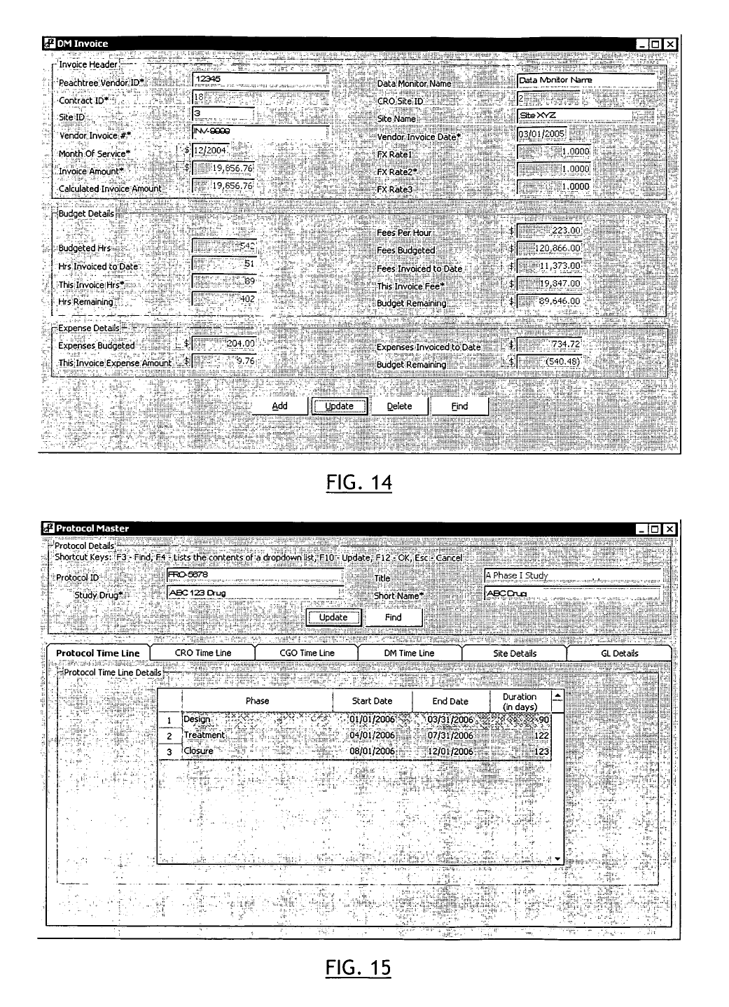

Referring to FIG. 14, the user can generate a DM invoice through a DM invoice screen. The user can record DM invoice details using this screen. The DM invoice screen displays original and available budget details and allows the user to enter actuals.

The invoice header contains the following fields: vendor ID, DM name, contract ID, CRO site ID, site ID, vendor invoice number, vendor invoice date, month of service, invoice amount, and the currency rate at end of month in which accrual is made for costs incurred.

The vendor ID is selected from a dropdown menu and is retrieved from the DM master. The DM name is selected from a dropdown menu and retrieved from the DM master. The contract ID is selected from a dropdown menu and retrieved for the particular vendor from information entered into the DM contract setup screen. The CRO ID is displayed in a text field labeled “CRO Site ID” and is retrieved from the DM contract setup for the particular vendor. The vendor invoice number is entered by the user in a numeric field labeled “vendor invoice #.” The vendor invoice date is entered by the user as a date (mm/dd/yyyy) in the field labeled “vendor invoice date.” The month for which an invoice is raised is entered as a date (mm/yyyy) in the field labeled “month of service.” The invoice amount is entered by the user in a numeric field labeled “invoice amount.” The exchange rate at the date when the contract is set up is retrieved from the DM contract setup screen, and displayed in a numeric field labeled “FX1 rate.” The exchange rate at end of month in which accrual is made for costs incurred is retrieved from information presented on the exchange rate master screen, FIG. 27, and displayed in a numeric field labeled “FX2 rate.” The currency rate at the time of payment is displayed in a numeric field labeled “FX3 Rate.”

Budget details are displayed on the mid section of the screen. These fields include: fees per hour, budgeted hours, fees budgeted, hours invoiced to date, fees invoiced to date, current invoice hours, current invoice fee, budgeted hours remaining, and amount of budget remaining. Fees per hour are retrieved from the DM contract setup for the selected vendor. The fees budgeted field is a calculated field, calculated as a product of the fees per hour and the number of budget hours. Hours invoiced to date are automatically calculated and displayed in field labeled “hours invoiced to date.” Total fees to date are automatically calculated from the invoices received, and displayed in a numeric field labeled “fees invoiced to date.” The number of hours for the current invoice is entered by the user in a field labeled “this invoice hours.” The current invoice fee is calculated by the user and entered as a product of invoiced hours and hourly fee rate, and is displayed in a numeric field labeled “this invoice fee.” The difference between the total budgeted hours, less the invoiced hours to date, is automatically calculated and displayed in a field labeled “hours remaining.” The total budget remaining is automatically calculated as the difference between fees budgeted and fees invoiced to date, including those of the current invoice. The balance remaining is displayed in a numeric field labeled “budget remaining.”

The expense details are displayed on the lower section of the screen. These fields include expenses budgeted, expenses invoiced to date, expense amount for current invoice, and budget remaining. The expenses budgeted are retrieved from budget details entered when the contract is set up. The amount is displayed in a numeric field. The expenses invoiced to date are automatically calculated based on the invoices received, and the amount is displayed in a numeric field labeled “expenses invoiced to date.” The expense amount of the current invoice is entered by the user in a numeric field labeled “this invoice expense amount.” The budget remaining per expense item is automatically calculated, incorporating the amount of the current invoice, and displayed in a numeric field labeled “budget remaining.”

Referring to FIG. 15, the protocol master screen displays the summary information on a protocol. For any selected protocol, the user can view overall, CRO, CGO, and DM time lines as well as site and GL details. Protocol ID, title and study drug comes from the clinical trial management system. The protocol ID is retrieved from a dropdown list and displayed in a text field labeled “protocol ID.” The title is retrieved from the clinical data base, and displayed in a text field labeled “title.” The in-house study drug field is selected from a dropdown list retrieved from the product master list. The user can then choose a short name for the study drug that is unique for the protocol table, and enter it in the text field labeled “short name.” The short name chosen will be used for reporting purposes, but not for forecasting purposes.

The protocol time line tab of the protocol master screen displays a consolidated time line derived from CRO, CGO, and DM timelines. All fields are display fields only, and the entries are derived from the contract setup screens. The fields are as follows: phase; amendment date; start date; end date; and duration (displayed in number of days.) These fields are displayed in a grid. Individual timelines can also be displayed in similar ways using CRO, CGO, and DM tabs.

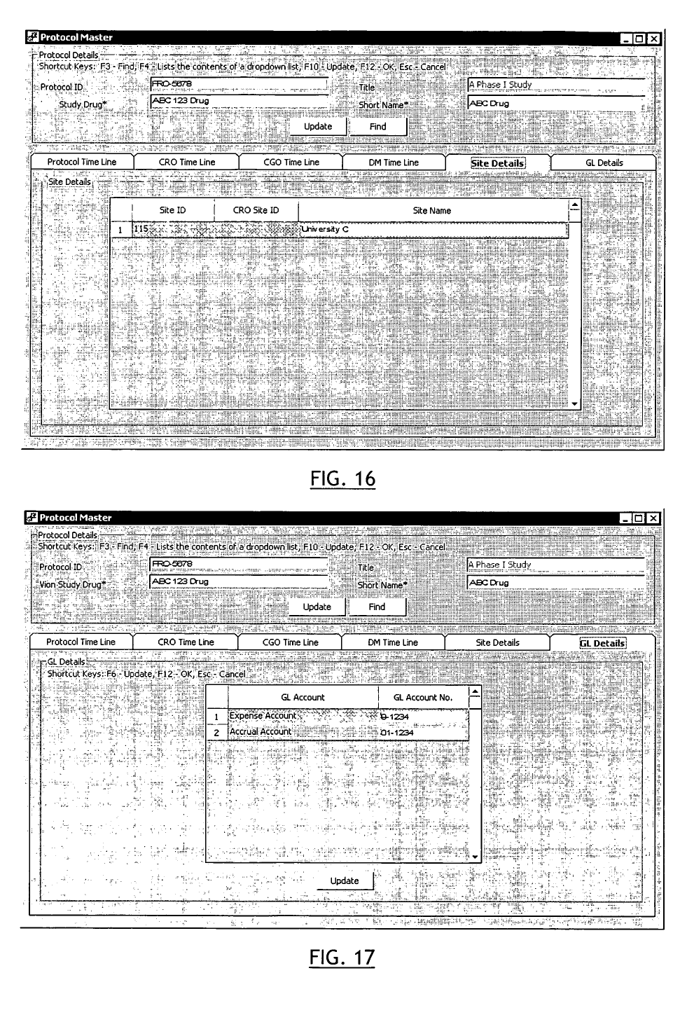

Referring to FIG. 16, a site details tab cross-references site names, site IDs, and CRO site IDs. The site ID number is retrieved from the clinical data base. Even if the same physical site is assigned to two different protocols, they will have two different site ID's. The CRO site ID is retrieved from the CRO contract setup and is displayed in a text field labeled “CRO site ID.”

Referring to FIG. 17, the user can access and update General Ledger (GL) account numbers for a protocol through a tab labeled “GL details” on the protocol master screen. Each Protocol will have two GL accounts, an expense GL account and an accrual GL account.

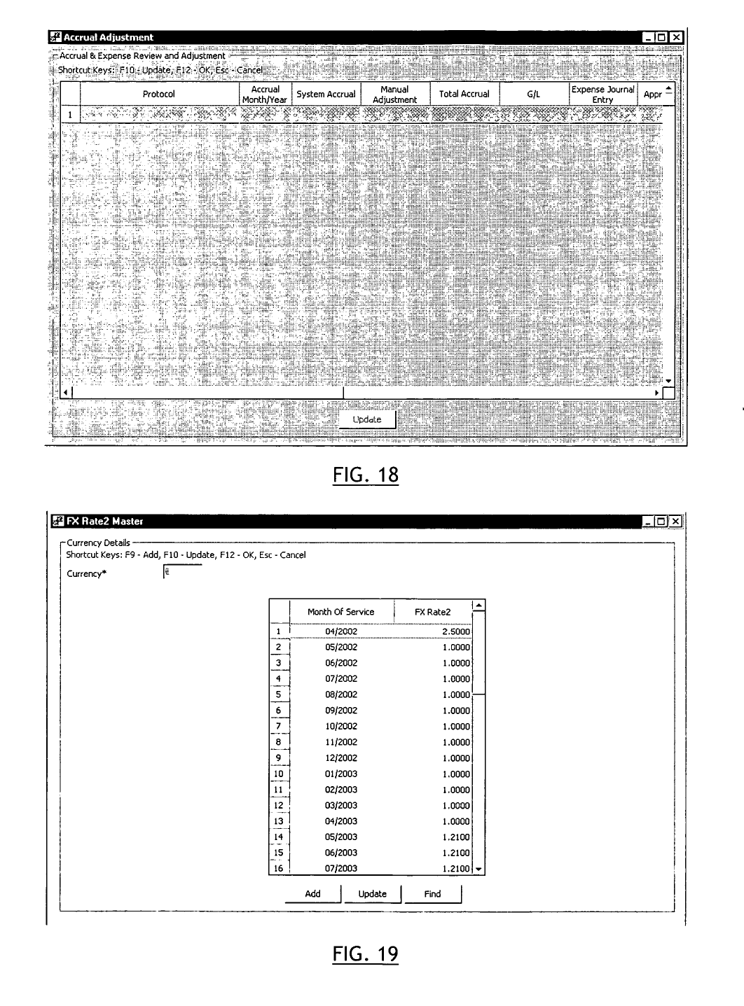

Referring to FIG. 18, an accrual adjustment screen displays a grid showing accrual details at protocol level. The user can perform manual adjustments and approve the accrual details. Once a month's accrual line item is approved it cannot be modified. The protocol number is displayed in the text field labeled “protocol.” The accrual month and year is displayed as a date (mm/yyyy) in a field labeled “accrual month/year.” The data from the month end accrual, retrieved from the last approved month, is displayed in the numeric field labeled “month end accruals.” The user may enter a manual adjustment to the general ledger in a field labeled “manual adjustment.” The total accrual, consisting of the sum of the automatically calculated system accrual and the manual adjustments, is automatically calculated and displayed in a field labeled “total accrual.” The balance of the general ledger is adjusted and displayed in a field labeled “G/L.” Expense journal entries are displayed in the field labeled “expense journal entries.” The user enters approval on each line item of accrual adjustments. By whom the adjustment is approved is selected from a dropdown list in a text field labeled “approved by.” The user enters the approved date (mm/dd/yyyy) in a field labeled “approved date.” The reason for the approval is entered by the user in a text field labeled “reason.” The user may attach text to this screen.

Referring to FIG. 19, the system tracks the exchange rates listed in table 1:

TABLE 1

| | |
|---|---|
| FX Rate 1 | Exchange rate on date contract is signed. |
| FX Rate 2 | Exchange rate at end of month in which accrual is made |
| | for costs incurred (invoice has not been received). |
| FX Rate 3 | Exchange rate at end of month in which invoice is |
| | received and dated for that month. |
| FX Rate 4 | Exchange rate on date payment is made. |

Three display fields on the invoice review screen (see FIG. 9) are provided for rates 2-4. The difference between FX3 and FX4 represents the gain/loss on the payment transaction that the company reports in “Other Income/Expense” in its Profit And Loss (P & L) statement.

Referring to FIG. 19, the user maintains rate 2 in an exchange rate master screen. This screen is updated monthly, and will maintain rate 2 for every month. The user can add, modify and delete month end exchange rates using this screen. Data fed in this screen is used in the accrual calculations. A currency type is selected from a dropdown list and entered in a text field labeled “currency.” The user enters the month of service as a date (mm/yyyy) in the field labeled month of service. The user enters the exchange rate in the numeric field labeled “FX Rate2.”

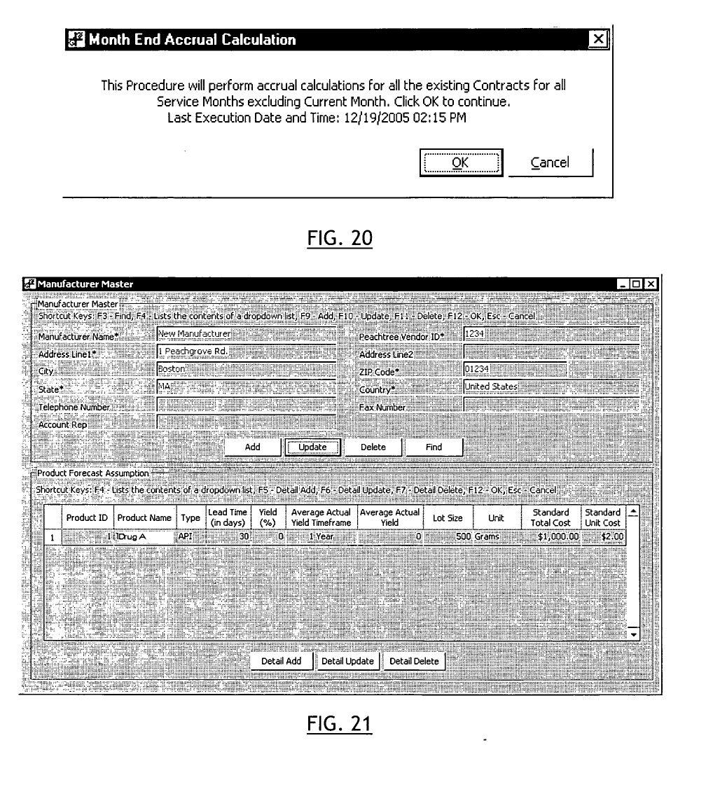

Referring to FIG. 20, a month-end accrual dialog will cause the financial management system to perform accrual calculations. It is, however, important that exchange rates be first updated using the exchange rate master screen. To this end, the accrual calculations will be performed only if the FX Rate master has month end exchange rates for all the months until the previous calendar month. Accrual will be calculated through the last approved month.

Referring to FIG. 21, the manufacturer master screen maintains manufacturer details. One manufacturer can have multiple products, and one product can be related to multiple manufacturers. Manufacturer contact details are entered in the top half of the screen.

Product forecast assumptions are displayed in a grid on the lower half of the screen. Product ID number, name, and type fields are derived from the product master screen. The product lead time is entered by the user as a number of days in an integer field labeled “lead time.” This number is for use in reports for production forecast. The product yield is automatically calculated as a ratio of the quantity received to the quantity ordered, and displayed as a percentage in a numeric field labeled “yield %.” The average will be calculated for all the purchase orders for the manufacturer for the average actual yield time frame. The user can view the average actual yield over an annual increment, and may select to view the product yield for 1, 2, 3, 4, or 5 year history.

The average actual yield is automatically calculated from the production forecasts purchase order screen (see FIG. 25), and displayed in a numeric field. Lot size is entered by the user in an integer field. Lot size is for user information only, it does not figure into the system calculations. The product unit is displayed in a text field labeled “unit.” Standard total cost is entered by the user in an integer field labeled “standard total costs.” Standard unit cost is then automatically calculated, and is displayed in an integer field.

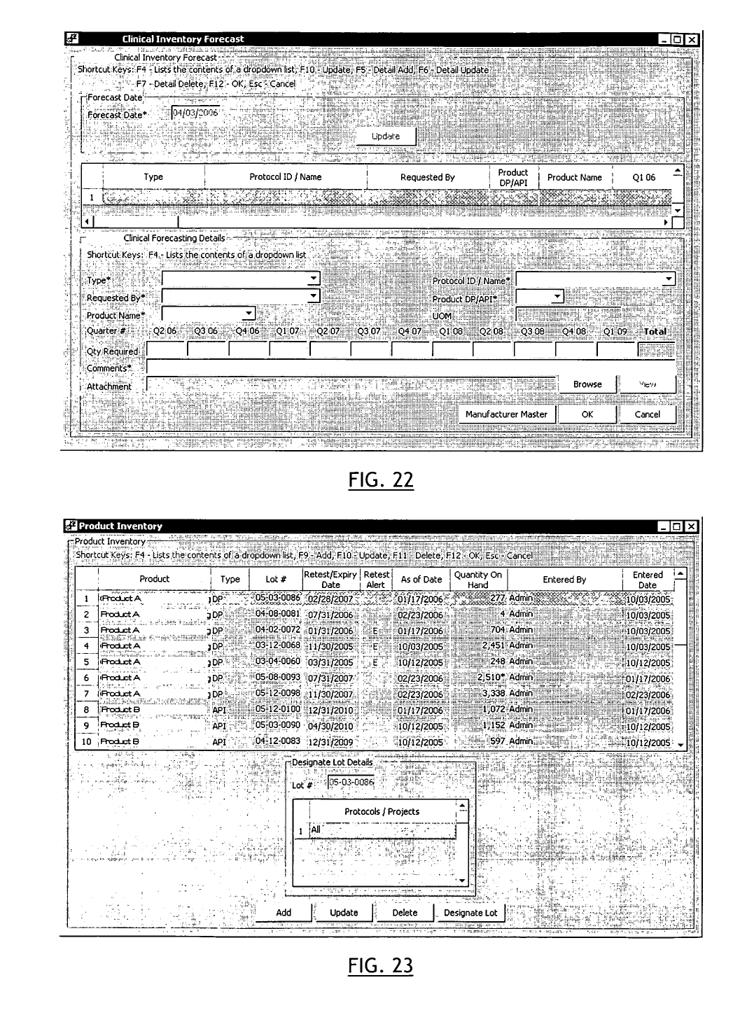

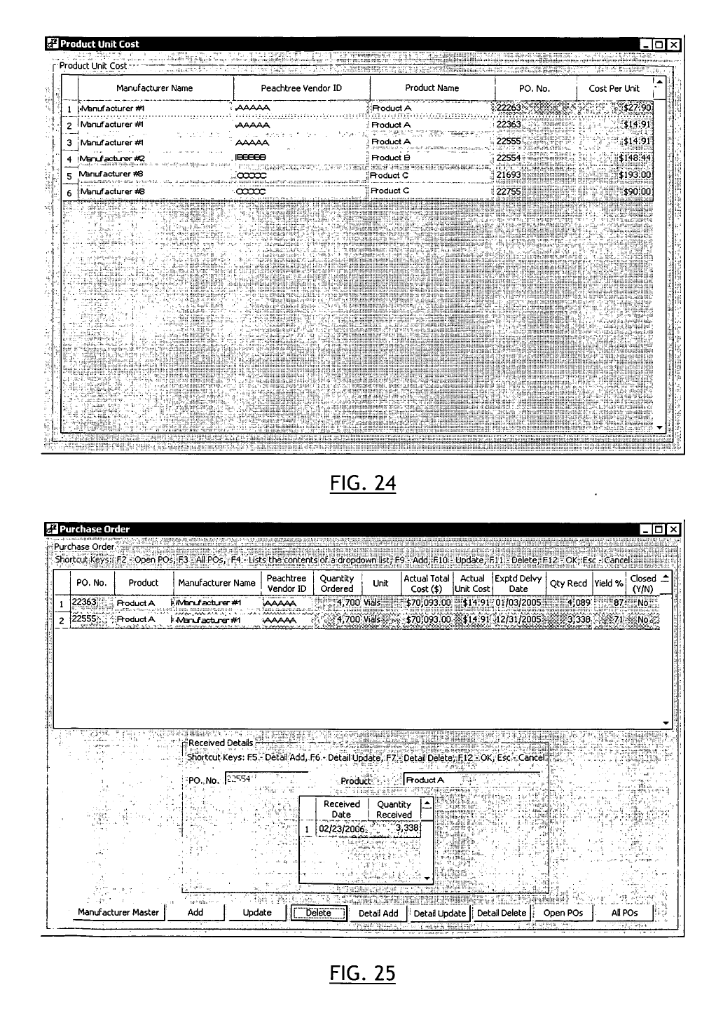

Referring to FIG. 22, an outsourced clinical forecast screen maintains forecast details for outsourced clinical inventory products. The user can enter or edit the next 12 quarter details, and the user may view one or more previous quarters.

The forecasting date is entered by the user in a date field. The product type is selected from a drop down list and displayed in a text field. The protocol ID/name is selected from a dropdown list and displayed in a text field. By whom the forecast is requested may be selected from a dropdown list that displays all user names. The user then selects from a dropdown menu whether the forecast is performed for a DP or an API. The corresponding product name is selected from a dropdown list and displayed in the text field labeled “product name.” The unit of measure is displayed in a text field labeled “UOM.” The user selects the desired number of quarters for which forecasting information is requested. The forecast numbers are automatically calculated and displayed in the corresponding integer fields. The user may also attach a text document or enter comments in the text field labeled “comments.”

Referring to FIG. 23, a product inventory screen maintains product inventory details. The user accesses this screen from the forecast menu. On screen load, a retest alert window instructs a user to enter the length of an expiration warning time period in days. One product can have multiple lot numbers. If the product has already expired, meaning that the retest date is less than the current date, then “E” will be displayed in a retest alert column. If the product is going to expire with the warning period entered in the retest alert screen, an exclamation mark (!) will be displayed in the retest alert column.

A product name is selected from a dropdown list of products created with the product master screen and is displayed in the text field labeled “product.” The corresponding product type, meaning whether the product is a DP or an API, is then displayed in a text field labeled “type.” A lot number is entered by the user in the field labeled “lot #.” The user also enters a retest/expiry date in a date field labeled “retest/expiry.” The user can select a date for which an inventory figure is desired by entering the date in the field labeled “as of date.” The user can enter the quantity on hand in an integer field so labeled for the date requested. By whom the inventory was counted is selected from a dropdown list and displayed in a text field labeled “entered by.” The user can also enter the date when the inventory number was entered in the system in the date field labeled “entered date.”

The user can then refer to the lower section of the screen to enter the lot designation details. This screen allows lots to be designated as approved for particular projects.

Referring to FIG. 25, a product unit cost screen allows a user to view the unit cost for a product by purchase order. The screen is accessed from the forecast screen. It is a read-only screen, which displays the unit price as it was entered in the purchase order screen. The product unit cost screen has a text display field for the manufacturer's name, the vendor ID number, the product name, the purchase order number, and the cost per unit.

A purchase order screen is accessed via the forecast main menu category. Purchase orders can be either open or closed. The user can view all purchase orders, update or edit open purchase orders, and record purchase order details using this screen. The user can record the quantity of a product received and measure it against the quantity ordered. In the illustrative embodiment, closed purchase orders can not be edited using the purchase order screen.

The user can enter the purchase order number in the text field labeled “PO No.” The product name can be selected from a dropdown list of products derived from earlier user entry at the product master screen. A manufacturer name is retrieved from a dropdown list of manufacturers for selected products, from the product master screen. The vendor ID number is displayed in the text field so labeled. The quantity of product ordered is entered by the user in the integer field labeled “quantity ordered.” A unit of measure is displayed in a text field labeled “unit.” The user enters the total cost of the product in the numeric field labeled “actual total cost(s).” The unit cost is automatically calculated and displayed in the numeric field labeled “actual unit cost.” The expected delivery date is entered by the user in the date field labeled “expected delivery date.” The quantity received is displayed in the integer field labeled “qty rec'd.” If the purchase order is a closed purchase order, then the system will automatically calculate the amount of product received relative to the amount ordered, and display the figure as a percent in the integer field labeled “yield %.” The user indicates whether the purchase order is open or closed by selecting yes or no in the dropdown list for the field labeled “closed Y/N.” The lower portion of the screen has a text box within which to record received details, including quantity and date received for a particular purchase order.

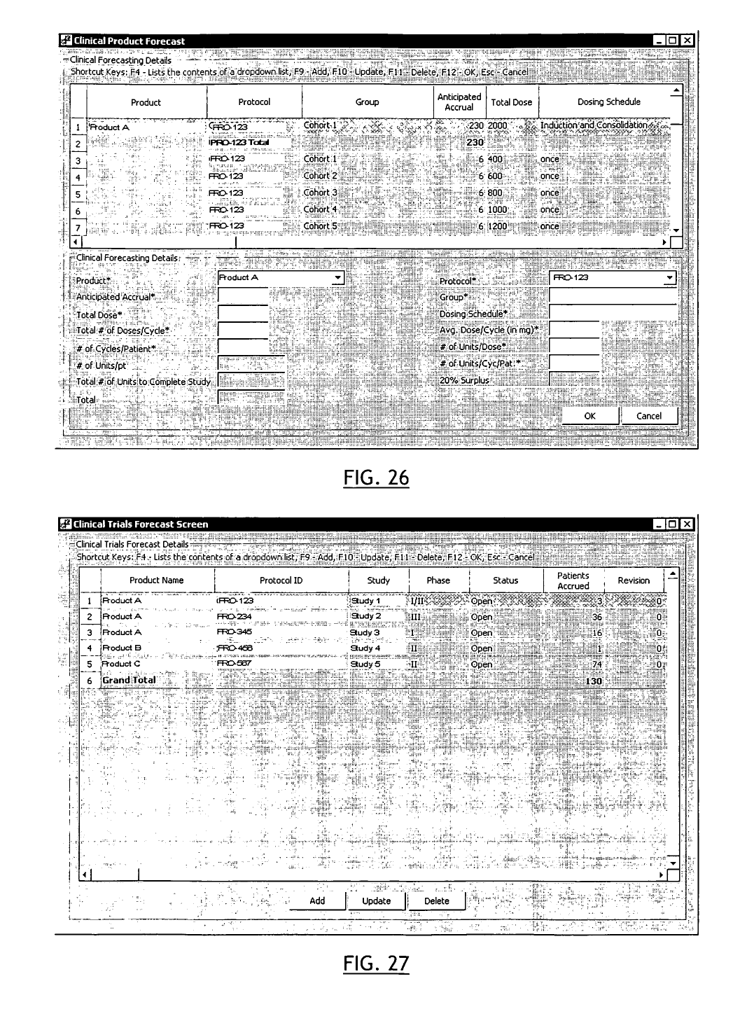

Referring to FIG. 26, a clinical product forecast screen maintains product requirement details. A product name is retrieved from the product master screen and displayed in a text field labeled “product.” A protocol ID number is retrieved from the protocol master screen and displayed in the text field labeled “protocol.” The user enters the anticipated accrual in the integer field labeled “anticipated accrual.” A group affiliation, referring to phase sequence or cohort number, is entered by the user in the text field labeled “group.” The total product dose is entered by the user in the field labeled “total dose.”

The user enters the dosing schedule in the text field labeled “dosing schedule.” The number of doses per cycle is entered by the user. The average dose per cycle in milligrams, the total number of cycles per patient, and the number of vials per dose are entered by the user. The number of vials per patient is automatically calculated as the product of the number of cycles per patient and the number of vials per cycle per patient. The number of vials per cycle per patient is entered by the user. The total number of vials to complete the study is automatically calculated as a product of the anticipated accrual and the number of vials per patient. Any surplus is displayed in the integer field labeled “surplus.” The total is automatically calculated and displayed in the field labeled “total.”

Referring to FIG. 27, a clinical trials forecast screen maintains the trials' forecast details. In the illustrative system, the user can enter or edit the next quarter details for up to 12 quarters. Budget details are displayed for each quarter for the selected protocol. The latest three revisions are to be maintained.

The product ID number and name are retrieved from the product master screen input and displayed together in the text field labeled “product ID/name.” The protocol ID number and the protocol name are retrieved from the protocol master screen and displayed in the text field labeled “protocol ID/protocol name.” The screen has fields that display a trial study identification number, a trial phase classification, and a status of the trial (whether the trial is open or closed). A number of patients accrued is displayed in an integer field. The number of revisions to the study, whether 1^{st}, 2^{nd}, or 3^{rd} is displayed in an integer field labeled “revision.” The number of patients used in the study is entered by the user in an integer field. The per-patient expenditure over 12 quarters is automatically calculated and displayed in the integer field labeled “per patient expenditure.” Total expenditures over 12 quarters is entered by the user in the integer field labeled “total expenses.” The total budgeted amount for the trial is displayed in the integer field labeled “bud. amt. $.”

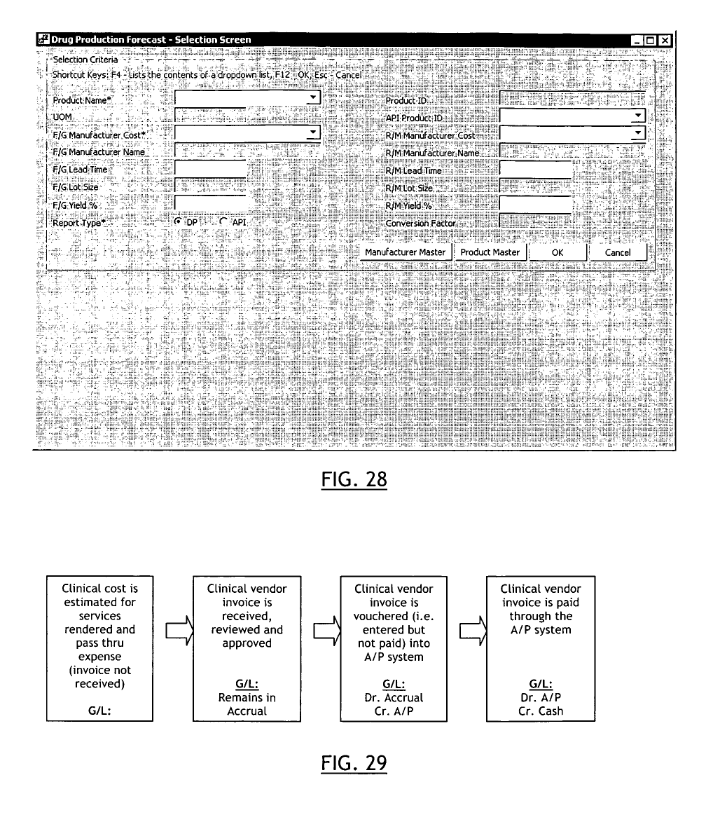

Referring to FIG. 28, a drug production forecast screen will display each quarter's product requirement based on clinical trial forecasts. The system allows for the user to track internal trials. This screen will also display the quantity to order based on the patient requirement and manufacturer yield. The user can perform manual adjustments on the quantity to order. The upper half of the screen displays the product selection criteria, including product name, unit of measure, manufacturer name and cost, production lead time, lot size, and yield.

The lower half of the screen has a text box with fields to display product requirement criteria for a determined number of patients. The screen also has a display field that exhibits the weighed average of product used per patient for the complete study. This number is derived from the clinical product forecast screen. There is a display field to exhibit the manufacturer cost for the quantity selected. This figure can be displayed out over 12 quarters. If an additional internal product is being used for the study, the amount of product taken from inventory can be displayed, and projected out over 12 quarters. The manufacturer cost for the inventory used will be displayed, and projected out over 12 quarters. There is a display field to exhibit total product requirements and total costs. The system automatically calculates and displays the order by date, based on the quarter start date and the lead time requirements.

At the bottom of the screen there are summary fields that display total needs and total costs. The system factors in available inventory, derived from the product inventory screen. The system also factors in open purchase orders to the summary totals. The information on open purchase orders is retrieved from the purchase order screen. The figure for the total order reflects total need, less available inventory, and less the amount reflected by open purchase orders. The system has a provision for the user to manually adjust this figure. The manufacturing cost for the total amount to be ordered is automatically calculated and displayed in a numeric field. The manufacturer's standard lot size is displayed. An audit trail is maintained for manual adjustments to the ordering figure, the date and user's name is recorded, the user enters a reason given for the manual adjustment.

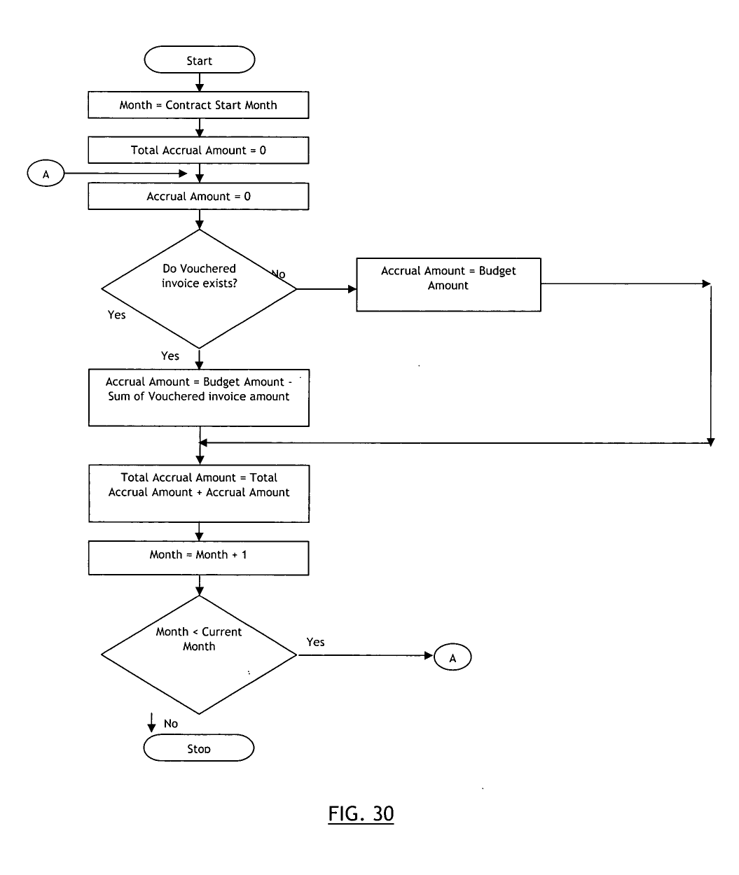

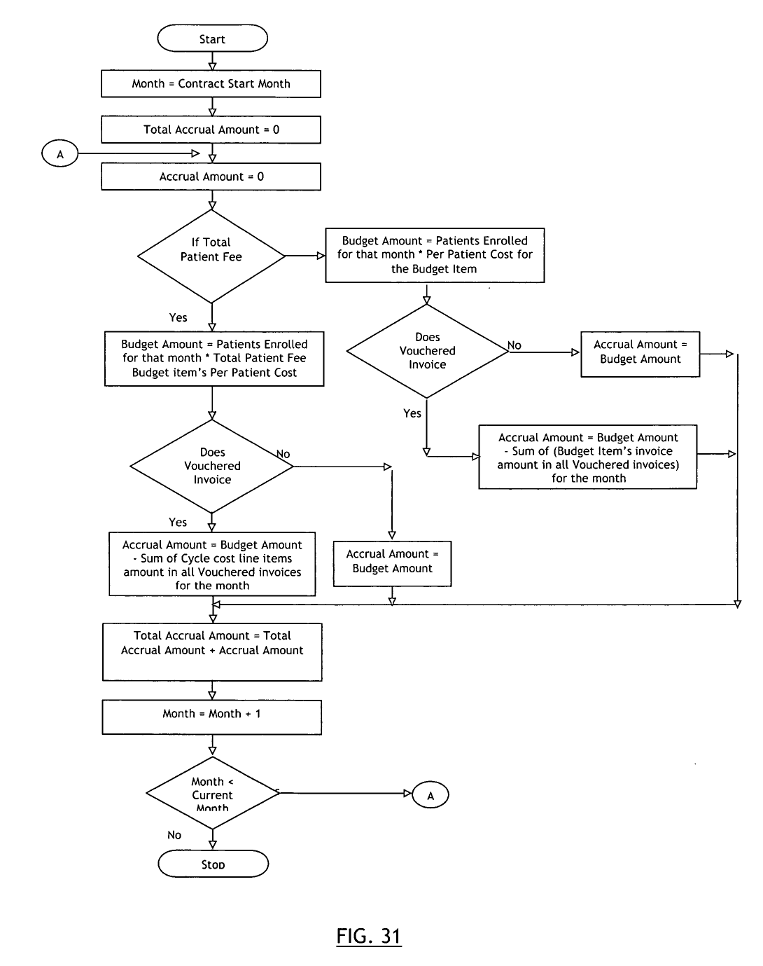

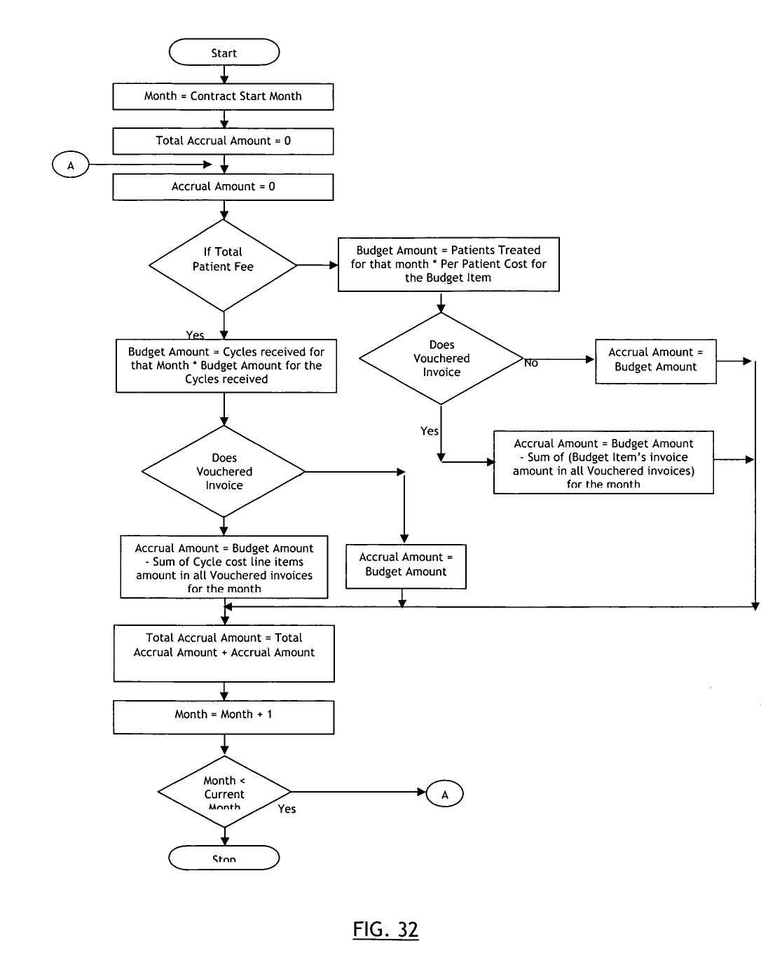

Referring to FIGS. 29-32, the clinical trial sponsor generally incurs third-party costs associated with its clinical trials, such as CRO, CGO, and DM costs. Sponsors are also generally required to expense clinical costs in the month in which the service is rendered, which is generally prior to receipt of a vendor invoice. The sponsor's month-end financial statements therefore generally include a clinical accrual, which contains the clinical cost expense for any and all budget line items for all months for which an invoice has not been “vouchered”.

The flow for this process in the case of the illustrative embodiment begins with accrual for clinical invoices received but not yet vouchered. This represents invoices that have been entered in the clinical trial financial management system database via one or more invoice review and approval screens with a status of either “posted” or “not posted,” but have not yet been checked off in the database using the invoice A/P screen as “vouchered.” Once an invoice is checked off as “vouchered,” it is recorded in the financial management system's accounts payable register, and as such no longer is included in the accounting accrual.

Accrual for estimated clinical costs incurred for which an invoice has not been received—represents a “best estimate” of costs to be billed for services received from third parties such as CGOs, CROs, DMs. The accrual is a calculation made at the budget line item level using budgeted total or per patient costs as one factor and different items for the second factor, such as number of patients enrolled/treated but not yet vouchered or number of months for project management fees not yet vouchered. Accrual for estimated clinical costs would be triggered by different events, such as patient accrual or passage of time in the timeline, depending on the cost type, as follows:

I. Cost Type 1, Lump Sum at Contract Start Date

A. Expense—the monthly expense for each cost type 1 line item is equal to the total budget line item amount. The expense is recorded in the month in which the “contract execution date” falls.

B. Accrual—the month-end accrual calculation includes this expense until the vendor invoice for this line item is vouchered in the database through the “invoice A/P” screen.

II. Cost Type 2, Expense Equally Each Month Over the Whole Contract Term

A. Expense—the monthly expense for each cost type 2 line item is calculated by dividing the total budget line amount by the number of months in the whole contract term per the CGO/CRO, as applicable, timeline details. For DMs, this is the only applicable cost type. The DM monthly expense is calculated by dividing the total budget amount by the contract duration in months per the “DM contract setup” screen.

B. Accrual—the month-end accrual calculation includes the monthly estimated actual expense for all months for which a vendor invoice for that service period and line item has not been vouchered in the database through the “invoice A/P” screen.

III. Cost Type 3, Expense as Patients are Enrolled (for CROs) or are Treated (for CGOs)

A. Expense—the monthly budget expense per patient for each cost type 3 line item is calculated by dividing the total budget line item amount by the total number of budgeted patients to be accrued for that CRO or CGO only as per the contract budget terms. The monthly estimated actual expense for each cost type 3 line item is calculated by multiplying the calculated monthly budget expense per patient by the number of patients actually enrolled (for CROS) or treated (for CGOs) for the month per the actual patient accruals entered by Clinical group into the Clinical Database. For DMs, this cost type is N/A.

B. Accrual—the month-end accrual calculation includes the monthly estimated actual expense for all months for which a vendor invoice for that patient ID and line item has not been vouchered in the Database “Invoice A/P” screen.

IV. Cost Type 4, Expense Equally Each Month During Treatment Phase

A. Expense—the monthly expense for each cost type 4 line item is calculated by dividing the total budget line amount by the number of months in the “treatment phase” per the CRO/CGO, as applicable, timeline details. For DMs, this cost type is not applicable.

B. Accrual—the month-end accrual calculation includes the monthly estimated actual expense for all months for which a vendor invoice for that service period and line item has not been vouchered in the database through the “invoice A/P” screen.

V. Cost Type 5, Expense Equally Each Month During Closure Phase

A. Expense—the monthly expense for each cost type 5 line item is calculated by dividing the total budget line amount by the number of months in the “closure phase” per the CGO/CRO, as applicable, timeline details. For DMs, this cost type is not applicable.

B. Accrual—the month-end accrual calculation includes the monthly estimated actual expense for all months for which a vendor invoice for that service period and line item has not been vouchered in the database through the “invoice A/P” screen.

VI. Cost Type 6, Option Fees

Not applicable to CROs, CGOs or DMs as budget line items assigned to this cost type will not be tracked for accrual or forecast expense purposes. These costs will be entered when budget is established and when actual costs are invoiced and as such will only be tracked for actual and budget purposes.

In the illustrative system, the expense and accrual is by default always stated in U.S. dollars. If the budget is denominated in a foreign currency, the amounts calculated above need to be translated using an appropriate exchange rate.

The set of cost types shown above can provide a great deal of flexibility in providing for accurate accrual of costs in a variety of situations. But it is by no means definitive or exhaustive. Other types of cost types could be developed, and different subsets of cost types will be particularly well suited to different types of contractual arrangements, organizational structures, and regulatory frameworks. The cost types can also be named in a way the best suits the needs of the sponsor and its contracting parties.

The sponsoring organization can extract a number of reports from the clinical trial financial management system database. Because much or all of the relevant financial information is centralized in this single database, the reports can provide particularly powerful insight into the financial aspects of a clinical trial. This can allow for versatile and highly accurate budgeting, auditing, planning, and forecasting.

As is well known, reports can extract information from any of the fields tracked by the database. The following is a list of common reports, but numerous others could of course be devised as required by contractual arrangements, organizational structures, and regulatory frameworks:
Clinical cost summary report—forecast
Protocol cost summary report
Protocol cost detailed report
Clinical contract budget report
Invoices by date report
Untreated patients report/patient number report
Vendor report
Clinical cost summary report—actuals/forecast
Clinical cost summary report—actuals by year
Accrual summary report
Accrual detailed report—by contract
Drug production forecast report
Drug forecast report—in-house sponsored clinical trails
Clinical contract administration report
Patient accrual report
Invoices by protocol report
Time line summary report
   Sponsor organizations should preferably retain a history of the reports that they generate on a regular basis. This provides a history of the state of the system over time. This operation could be performed manually or automatically.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A clinical trial finance management system, comprising:
a clinical trial interface operative to interact with clinical trial data associated with a clinical trial plan,
a financial management interface operative to interact with financial data associated with the clinical trial plan, and
relationship management logic operative to interact with the clinical trial interface, operative to interact with the financial management interface, and operative to manage relationships between the clinical trial data and the financial data based on the clinical trial plan.

2. The system of claim 1 wherein the clinical trial interface includes a system interface operative to interact with a clinical trial management system that uses the clinical trial data.

3. The system of claim 1 wherein the financial management interface includes a system interface operative to interact with a financial management system that uses the financial data.

4. The system of claim 1 wherein the financial management interface includes a user interface that includes controls that allow the user to access the financial data.

5. The system of claim 1 wherein the relationship management logic is operative to manage relationships at the patient level.

6. The system of claim 1 wherein the relationship management logic is operative to manage relationships at the protocol level.

7. The system of claim 1 wherein the relationship management logic includes cost-type logic that associates different types of clinical trial items with different types of financial treatments.

8. The system of claim 7 wherein the cost-type logic includes mandatory selection logic that requires users to classify at least some clinical trial items by cost type.

9. The system of claim 8 wherein the relationship management logic includes hierarchical clinical trial item organization logic.

10. The system of claim 9 wherein the stored relationship selection interface is operative to present a tree-based user interface window to the user.

11. The system of claim 1 wherein the relationship management logic includes hierarchical clinical trial item organization logic.

12. The system of claim 11 wherein the stored relationship management logic is operative to present a tree-based user interface window to the user.

13. The system of claim 1 wherein the clinical trial plan is defined by clinical trial contract line items and wherein the relationship management logic is operative to associate different types of clinical trial contract line items from the clinical trial management system with different types of financial items.

14. The system of claim 1 wherein the relationship management logic includes audit trail logic operative to create audit trails for the relationships.

15. The system of claim 14 wherein the audit trail logic is designed to conform to predetermined compliance standards.

16. The system of claim 1 further including supply management logic operative to manage relationships between supply costs with patient-level clinical trial management data from the clinical trial management system.

17. The system of claim 16 further including fulfillment logic operative to manage fulfillment of clinical trial materials.

18. The system of claim 16 further including inventory management logic operative to manage inventory for clinical trial materials.

19. The system of claim 16 further including forecast logic operative to derive forward-looking cost information based on the supply management logic.

20. The system of claim 1 further including report logic operative to generate reports summarizing information from the system.

21. The system of claim 1 further including state logic operative to log states of the system over time.

22. The system of claim 1 further including management approval logic operative to gate functionality in the system based on management approval input.

23. The system of claim 1 further including forecast logic operative to derive forward-looking cost information based on patient-level clinical trial management data from the clinical trial management system.

24. The system of claim 1 further including a plurality of different management tools for different relationship management tasks.

25. The system of claim 1 wherein the system further includes accrual calculation logic operative to calculate accrued costs for a clinical trial.

26. The system of claim 1 wherein the system further includes invoicing logic operative to manage invoices for services or materials for a clinical trial.

27. The system of claim 1 wherein the system further includes expense tracking logic operative to track expenses for a clinical trial.

28. The system of claim 1 wherein the relationship management logic includes exchange rate calculation logic operative to capture exchange rates at discrete points over time to enable tracking of changes in costs.

29. A clinical trial finance management method, comprising:
accessing clinical trial data associated with a clinical trial plan,
accessing financial data associated with the clinical trial plan, and
automatically maintaining a set of relationships between the clinical trial data from the step of accessing a clinical trial management system and the financial data from the step of accessing financial data based on the clinical trial plan.

30. A clinical trial finance management system, comprising:
means for accessing clinical trial data associated with a clinical trial plan,
means for accessing financial data associated with the clinical trial plan, and
means for automatically maintaining a set of relationships between the clinical trial data accessed by via the means for accessing clinical trial data and the financial data accessed via the means for accessing financial data, based on the clinical trial plan.
